(19) United States
(12) Patent Application Publication
(10) Pub. No.: US 2021/0403756 A1
(43) Pub. Date: Dec. 30, 2021

(54) SLURRY COMPOSITION FOR CHEMICAL MECHANICAL POLISHING

(71) Applicant: SAMSUNG ELECTRONICS CO., LTD., Suwon-si (KR)

(72) Inventors: Inkwon KIM, Hwaseong-si (KR); Yearin BYUN, Hwaseong-si (KR); Boyun KIM, Hwaseong-si (KR); Seungho PARK, Suwon-si (KR); Hyosan LEE, Hwaseong-si (KR)

(21) Appl. No.: 17/354,403

(22) Filed: Jun. 22, 2021

(30) Foreign Application Priority Data
Jun. 25, 2020 (KR) 10-2020-0078045

(51) Int. Cl. C09G 1/02

(52) U.S. Cl. CPC C09G 1/02

(57) ABSTRACT

A slurry composition for a chemical mechanical polishing (CMP) process, the slurry composition including an organic polishing booster including an iminium cation; a carrier; and optionally including inorganic polishing particles, wherein, when included, the inorganic polishing particles are included in the slurry composition in an amount of less than 0.1% by weight, based on a total weight of the slurry composition.

### CROSS-REFERENCE TO RELATED APPLICATION

Korean Patent Application No. 10-2020-0078045, filed on Jun. 25, 2020, in the Korean Intellectual Property Office, and entitled: “Slurry Composition for Chemical Mechanical Polishing,” is incorporated by reference herein in its entirety.

### BACKGROUND

### 1. Field

Embodiments relate to a slurry composition for a chemical mechanical polishing (CMP) process.

### 2. Description of the Related Art

Polishing agents (or abrasives), such as inorganic polishing particles, may be added to a slurry composition for a CMP process.

### SUMMARY

The embodiments may be realized by providing a slurry composition for a chemical mechanical polishing (CMP) process, the slurry composition including an organic polishing booster including an iminium cation; a carrier; and optionally including inorganic polishing particles, wherein, when included, the inorganic polishing particles are included in the slurry composition in an amount of less than 0.1% by weight, based on a total weight of the slurry composition.

The embodiments may be realized by providing a slurry composition for a chemical mechanical polishing (CMP) process, the slurry composition including an organic polishing booster; a surfactant; and a carrier, wherein the organic polishing booster is included in the slurry composition in an amount of about 10 ppm to about 10,000 ppm by weight, and the slurry composition is essentially free of inorganic polishing particles.

The embodiments may be realized by providing a slurry composition for a polysilicon polishing process, the slurry composition including an organic polishing booster including an iminium cation; a surfactant; a pH control agent; and a carrier, wherein a pH of the slurry composition is in a range of about 2 to about 5, and the slurry composition is essentially free of inorganic polishing particles and a dispersion stabilizer for uniform distribution of the inorganic polishing particles.

### BRIEF DESCRIPTION OF THE DRAWINGS

Features will become apparent to those of skill in the art by describing in detail exemplary embodiments with reference to the attached drawings in which:

FIG. 1 is a perspective view of a polishing apparatus capable of performing a chemical mechanical polishing (CMP) process; and

FIGS. 2A to 2M are cross-sectional views of stages in a method of manufacturing a semiconductor device according to an embodiment.

### DETAILED DESCRIPTION

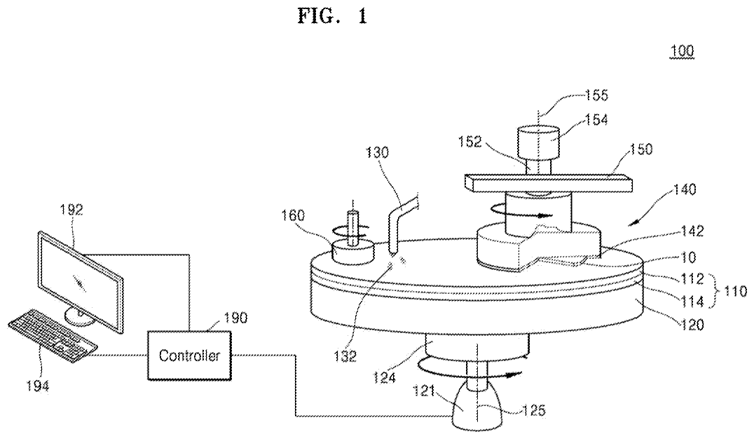

FIG. 1 is a perspective view of a polishing apparatus 100 capable of performing a chemical mechanical polishing (CMP) process.

Referring to FIG. 1, the polishing apparatus 100 may include a platen 120 having a rotating disc shape on which a polishing pad 110 is placed. The platen 120 may be capable of rotating about a central axis 125 thereof. In an implementation, a motor 121 may turn a driving axis 124 to rotate the platen 120. The polishing pad 110 may be a polishing pad having at least two layers including an outer polishing layer 112 and a backing layer 114 that is more flexible than the outer polishing layer 112.

The polishing apparatus 100 may include a slurry port 130 configured to dispense a polishing agent 132 (e.g., slurry) toward the polishing pad 110. The polishing apparatus 100 may include a polishing pad conditioner 160 configured to condition the polishing pad 110 so that the polishing pad 110 may be maintained in a consistent polishing state.

The polishing apparatus 100 may include at least one carrier head 140. The carrier head 140 may be configured to hold a substrate 10 against the polishing pad 110 The carrier head 140 may independently control polishing parameters (e.g., pressure) associated with each substrate.

In an implementation, the carrier head 140 may include a retaining ring 142 to hold the substrate 10 under a flexible membrane. The carrier head 140 may include a plurality of pressurizable chambers, which may be defined by the flexible membrane and controlled independently. The plurality of pressurizable chambers may independently apply controllable pressures to associated zones of the flexible membrane and the substrate 10.

The carrier head 140 may hang from a support structure 150 (e.g., a carousel or a track) and be connected to a carrier head rotational motor 154 by a driving axis 152, and thus, the carrier head 140 may rotate about a central axis 155. In an implementation, the carrier head 140 may oscillate in a lateral direction, e.g., on a slider on the carousel or the track or oscillate due to rotary oscillation of the carousel. During operation, the platen 120 may rotate about the central axis 125 thereof, and the carrier head 140 may rotate the central axis 155 thereof and be translated across a top surface of the polishing pad 110 in the lateral direction.

In an implementation, only one carrier head 140 may be included, as is illustrated in FIG. 1, or at least two carrier heads for maintaining additional substrates may be provided to efficiently use a surface area of the polishing pad 110.

The polishing apparatus 100 may also include a control system configured to control rotation of the platen 120. The control system may include a controller 190 (e.g., a general-use programmable digital computer), an output device 192 (e.g., a monitor), and an input device 194 (e.g., a keyboard).

In an implementation, as illustrated in FIG. 1, the control system may be connected only to the motor 121, or the control system may be also connected to the carrier head 140 and control a pressure or rotation speed of the carrier head 140. In an implementation, the control system may be connected to the slurry port 130 and control the supplying of slurry.

An embodiment provides a slurry composition for a CMP process, which may be used for the polishing apparatus 100.

The slurry composition may include an organic polishing booster and a carrier.

Organic Polishing Booster

The organic polishing booster may include an iminium cation. In an implementation, the iminium cation may include, e.g., an imidazolium cation, a pyridinium cation, a triazolium cation, or a guanidinium cation. As used herein, the term “or” is not an exclusive term, e.g., “A or B” would include A, B, or A and B.

In an implementation, the organic polishing booster may include an imidazolium cation represented by Formula A1.

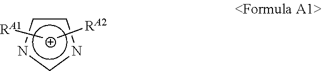

In Formula A1, R^{A1} and R^{A2} may each independently be or include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof. In an implementation, R^{A1} and R^{A2} may be separate or may be linked to each other to form a ring.

In an implementation, the imidazolium cation may be represented by, e.g., Formula 1 or Formula 2.

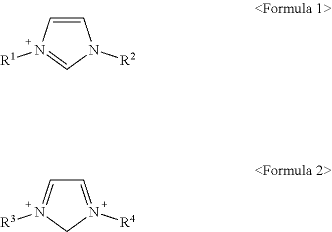

In Formulae 1 and 2, R¹, R², R³, and R⁴ may each independently be or include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof. In an implementation, R¹ and R² may be separate or may be linked to each other to form a ring, and R³ and R⁴ may be separate or may be linked to each other to form a ring.

In an implementation, the pyridinium cation may be represented by, e.g., Formula 3.

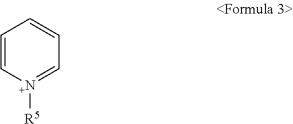

In Formula 3, R⁵ may be or may include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof.

In an implementation, the triazolium cation may be represented by, e.g., Formula A2 or Formula A3.

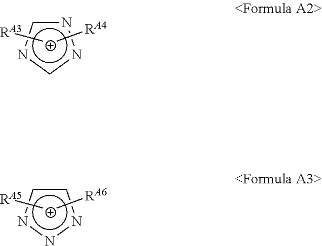

In Formulae A2 and A3, R^{A3}, R^{A4}, R^{A5}, and R^{A6} may each independently be or include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof. In an implementation, R^{A3} and R^{A4} may be separate or may be linked to each other to form a ring, and R^{A5} and R^{A6} may be separate or may be linked to each other to form a ring.

In an implementation, the triazolium cation may be represented by, e.g., Formula 4, Formula 5, or Formula 6

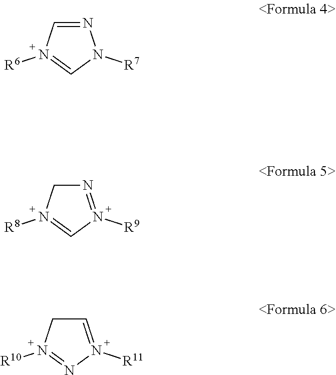

In Formulae 4 to 6, R⁶, R⁷, R⁸, R⁹, R¹⁰, and R¹¹ may each independently be or include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof. In an implementation, R⁶ and R⁷ may be separate or may be linked to each other to form a ring, R⁸ and R⁹ may be separate or may be linked to each other to form a ring, and R¹⁰ and R¹¹ may be separate or may be linked to each other to form a ring.

In an implementation, the guanidinium cation may be represented by, e.g., Formula 7.

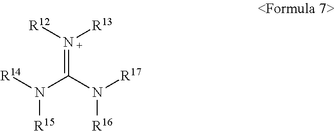

In Formula 7, R¹², R¹³, R¹⁴, R¹⁵, R¹⁶, and R¹⁷ may each independently be or include, e.g., hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof. In an implementation, and any two (e.g., adjacent ones) of R¹², R¹³, R¹⁴, R¹⁵, R¹⁶, and R¹⁷ may be separate or may be linked to each other to form a ring.

In an implementation, in Formulae 1 to 7, the C1 to C20 straight-chain alkyl group may each independently include, e.g., methyl, ethyl, n-propyl, n-butyl, or n-pentyl.

In an implementation, in Formulae 1 to 7, the C3 to C20 branched alkyl group may each independently include, e.g., isopropyl, isobutyl, tert-butyl, sec-butyl, isopentyl, neopentyl, sec-pentyl, sec-isopentyl, or 3-pentyl.

In an implementation, in Formulae 1 to 7, the C3 to C20 cycloalkyl group may each independently include, e.g., cyclopropyl, cyclobutyl, cyclopentyl, or cyclohexyl.

In an implementation, in Formulae 1 to 7, the C2 to C20 alkenyl group may each independently include, e.g., ethylenyl, propylenyl, or butylenyl.

In an implementation, in Formulae 1 to 7, the C6 to C20 aryl group may each independently include, e.g., phenyl, naphthyl, tolyl, or xylyl.

In an implementation, the organic polishing booster of Formulae 1 to 7 described above may be a monomer, which may be polymerized depending on a substituent. In an implementation, when the substituent has a vinyl group (e.g., —CH═CH₂) including a double bond, an oligomer or a polymer may be formed due to polymerization. In an implementation, the organic polishing booster may include the oligomer or the polymer.

In an implementation, R² in Formula 1 may be a vinyl group, the compound of Formula 1 may have a structure represented by Formula 1a, and may be polymerized to obtain a compound including a moiety represented by Formula 8′ (e.g., a polymer or oligomer including “m” number of repeating units).

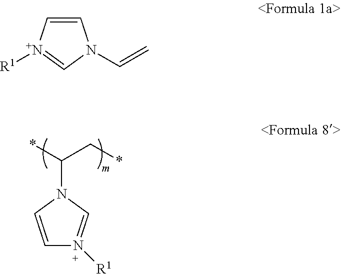

In an implementation, R⁷ of Formula 4 may be a vinyl group, the compound of Formula 4 may have a structure represented by Formula 4a, and may be polymerized to obtain a compound including moiety represented by Formula 9′ (e.g., a polymer or oligomer including “m” number of repeating units).

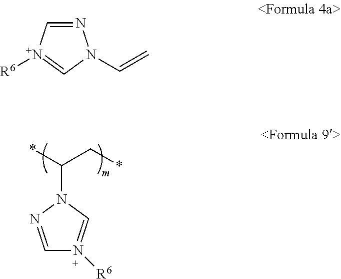

In an implementation, R⁵ of Formula 3 may be a vinyl group, the compound of Formula 3 may have a structure represented by Formula 3a, and may be polymerized to obtain a compound including a moiety represented by Formula 10′ (e.g., a polymer or oligomer including “m” number of repeating units).

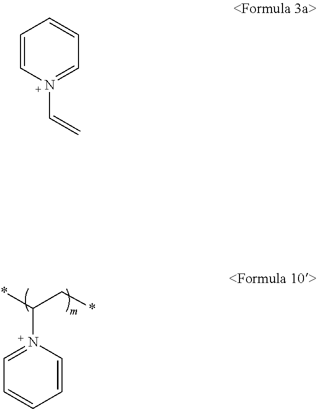

In an implementation, an oligomer or polymer obtained by polymerizing the organic polishing booster of Formulae 1 to 7 may have a weight-averaged molecular weight of, e.g., about 3,000 to about 100,000. In an implementation, the oligomer or the polymer may have a weight-averaged molecular weight of, e.g., about 5,000 to about 90,000, about 8,000 to about 80,000, about 10,000 to about 70,000, about 15,000 to about 60,000, or about 20,000 to about 50,000.

The weight-averaged molecular weight may be, e.g., measured by gel permeation chromatography (GPC) using polystyrene as a standard.

The organic polishing booster may be included in the slurry composition for the CMP process in an amount of, e.g., about 10 ppm to about 10,000 ppm by weight. In an implementation, the organic polishing booster may be included in an amount of, e.g., about 30 ppm to about 9,000 ppm by weight, about 100 ppm to about 8,000 ppm by weight, about 150 ppm to about 7,000 ppm by weight, about 300 ppm to about 6,500 ppm by weight, about 500 ppm to about 6,000 ppm by weight, about 800 ppm to about 5,500 ppm by weight, or about 1000 ppm to about 5,000 ppm by weight.

Including a sufficiently high amount of the organic polishing booster in the slurry composition for the CMP process may help ensure that a polishing effect is satisfactory. Including a sufficiently low amount of the organic polishing booster in the slurry composition for the CMP process may facilitate controlling of a polishing rate.

The carrier may be a suitable liquid capable of substantially uniformly dispersing the organic polishing booster. The carrier may be, e.g., an aqueous solvent or an organic solvent.

In an implementation, the carrier may include, e.g., water, deionized water (DIW), ultrapure water, an alcohol (e.g., propenyl alcohol, isopropyl alcohol, ethanol, 1-propanol, methanol, or 1-hexanol), an aldehyde (e.g., formaldehyde or acetaldehyde), an ester (e.g., ethyl formate, propyl formate, ethyl acetate, methyl acetate, methyl lactate, butyl lactate, or ethyl lactate), a ketone (e.g., acetone, diacetone alcohol, or methyl ethyl ketone), dimethyl sulfoxide (DMSO), tetrahydrofuran, dioxane, diglyme, an amide (e.g., N,N-dimethyl formamide, dimethyl imidazolidinone, or N-methyl pyrrolidone), a polyhydric alcohol and derivatives thereof (e.g., ethylene glycol, glycerol, diethylene glycol, or diethylene glycol monomethyl ether), a nitrogen-containing organic compound (e.g., acetonitrile, amylamine, isopropylamine, imidazole, or dimethyl amine), or a mixture thereof.

The amount of the carrier may be a residual portion or balance amount, excluding the organic polishing booster and other components to be described below.

In an implementation, the slurry composition for the CMP process may include inorganic polishing particles in an amount of, e.g., less than about 0.1% by weight. The inorganic polishing particles may be suitable inorganic particles (e.g., metal oxide particles), which are widely used for a slurry composition for a CMP process.

In an implementation, the slurry composition for the CMP process may include the inorganic polishing particles in an amount, e.g., of less than about 0.08% by weight, less than about 0.05% by weight, less than about 0.03% by weight, less than about 0.01% by weight, less than about 0.008% by weight, less than about 0.005% by weight, less than about 0.003% by weight, less than about 0.001% by weight, less than about 0.0008% by weight, less than about 0.0005% by weight, less than about 0.0003% by weight, or less than about 0.0001% by weight (e.g., based on a total weight of the slurry composition).

In an implementation, the slurry composition for the CMP process may not include the inorganic polishing particles (e.g., may be essentially free of inorganic polishing particles). In an implementation, the slurry composition for the CMP process may not include metal oxide particles. In an implementation, the slurry composition for the CMP process may not include any of silica, alumina, ceria, titania, zirconia, magnesia, germania, and mangania.

Here, when some particles are referred to as being ‘not included,’ or the composition being “essentially free of” the particles, it indicates that the particles are not intentionally added, but it does not indicate that the particles are not present at all or exist below a detection limit. Accordingly, the slurry composition for the CMP process may include the particles in an amount similar to that of unavoidable impurities.

Depending on polishing conditions, some inorganic polishing particles included in a slurry composition for a CMP process may damage a semiconductor device formed on a polishing object. For example, the inorganic polishing particles may damage layers, wirings, and patterns formed on the polishing object. Alternatively, even when a polishing process ends, the inorganic polishing particles may not be sufficiently removed and could cause contamination.

In addition, some inorganic polishing particles could reduce the lifespan of a polishing pad (refer to 110 in FIG. 1) used for a polishing process, and the inorganic polishing particles may become the cause of a replacement cost of the polishing pad 110 and an opportunity cost caused by a downtime for a replacement of the polishing pad 110.

In an implementation, if the organic polishing booster is appropriately selected, a sufficient polishing rate may be obtained without the need for inorganic polishing particles. When the inorganic polishing particles are not included in the slurry composition for the CMP process, damage to and contamination of a polishing object may be reduce or prevented, and the abrasion of the polishing pad may be reduced, thereby reducing manufacturing costs. In addition, the manufacturing costs may be further reduced in that the slurry composition itself for the CMP process may be inexpensive.

The slurry composition for the CMP process may not include a dispersion stabilizer. The slurry composition for the CMP process may not include inorganic polishing particles as described above, and a dispersion stabilizer (that may otherwise be added to obtain good dispersion of inorganic polishing particles) may be unnecessary.

In an implementation, the slurry composition for the CMP process may not include any one of ethylene oxide, ethylene glycol, glycol distearate, glycol monostearate, glycol polymerate, glycol ethers, alcohols containing alkylamine, compounds including polymerate ether, vinyl pyrrolidone, celluloses, and ethoxylate as the dispersion stabilizer. In an implementation, the slurry composition for the CMP process may not include, as the dispersion stabilizer, any one of diethylene glycol hexadecyl ether, decaethylene glycol hexadecyl ether, diethylene glycol octadecyl ether, eicosaethylene glycol octadecyl ether, diethylene glycol oleyl ether, decaethylene glycol oleyl ether, decaethylene glycol octadecyl ether, nonylphenol polyethylene glycol ether, ethylenediamine tetrakis(ethoxylate-block-propoxylate) tetrol, ethylenediamine tetrakis(propoxylate-block-ethoxylate) tetrol, polyethylene-block-poly(ethylene glycol), polyoxyethylene isooctylphenyl ether, polyoxyethylene octylphenyl ether, polyoxyethylene tridecyl ether, polyoxyethylene sorbitan tetraoleate, polyoxyethylene sorbitol hexaoleate, polyethylene glycol sorbitan monolaurate, polyoxyethylene sorbitan monolaurate, sorbitan monopalmitate, FS-300 nonionic fluorosurfactant, FSN nonionic fluorosurfactant, FSO nonionic ethoxylated fluorosurfactant, vinyl pyrrolidone, 2,4,7,9-tetramethyl-5-decyne-4,7-diol ethoxylate, 8-methyl-1-nonanol propoxylate-block-ethoxylate, allyl alcohol 1,2-butoxylate-block-ethoxylate, polyoxyethylene branched nonylcyclohexyl ether, and polyoxyethylene isooctylcyclohexyl ether.

pH Control Agent

In an implementation, the slurry composition for the CMP process may further include a pH control agent for controlling a pH of the composition. In an implementation, the slurry composition for the CMP process may have a pH of, e.g., about 1 to about 9. In an implementation, the slurry composition for the CMP process may have a pH of, e.g., about 2 to about 7. In an implementation, the slurry composition for the CMP process may have a pH of, e.g., about 2 to about 5.

To control a pH of the slurry composition for the CMP process as needed, an acidic solution and an alkali solution may be appropriately used. In an implementation, the pH control agent may include an acidic solution (e.g., sulfuric acid, phosphoric acid, hydrochloric acid, nitric acid, carboxylic acid, maleic acid, malonic acid, citric acid, oxalic acid, or tartaric acid) or an alkali solution (e.g., calcium hydroxide, potassium hydroxide, ammonium hydroxide, sodium hydroxide, magnesium hydroxide, triethylamine, tetra methyl ammonium hydroxide (TMAH), or ammonia). The pH control agent may be included in the slurry composition for the CMP process at such an amount that the pH of the slurry composition for the CMP process is in a desired range.

Surfactant

In an implementation, the slurry composition for the CMP process may further include a surfactant as desired. In an implementation, the surfactant may include, e.g., a non-ionic surfactant, a cationic surfactant, an anionic surfactant, or an amphoteric surfactant.

The non-ionic surfactant may include, e.g., polyoxyethylene alkylethers such as polyoxyethylene laurylether and polyoxyethylene stearylether; polyoxyethylene alkylphenylethers such as polyoxyethylene octylphenylether and polyoxyethylene nonyl phenylether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerine higher fatty acid esters such as oleic acid monoglyceride and stearic acid monoglyceride; polyoxyalkylenes such as polyoxyethylene, polyoxypropylene, and polyoxybutylene, or block copolymers thereof.

The cationic surfactant may include, e.g., alkyl trimethyl ammonium chloride, dialkyl dimethyl ammonium chloride, benzalkonium chloride, or alkyl dimethyl ammonium ethosulfate.

The anionic surfactant may include, e.g., carboxylic acid salts such as lauric acid sodium, oleic acid sodium, N-acyl-N-methylglycine sodium salts, and polyoxyethylene laurylether carboxylic acid sodium, sulfonates such as dodecylbenzene sulfonic acid sodium, dialkyl sulfosuccinate ester salts, and dimethyl-5-sulfoisophthalate sodium, ester sulfates such as sodium lauryl sulphate (SLS), sodium lauryl polyoxyethylene ether sulphate, and polyoxyethylene nonylphenyl ether sodium sulfate, or ester phosphates such as polyoxyethylene lauryl sodium phosphate and polyoxyethylene nonylphenyl ether sodium phosphate.

The amphoteric surfactant may include, e.g., a carboxybetaine surfactant, aminocarboxylic acid salts, imedazolinium betaine, lecithin, or alkylamineoxide.

The surfactant may be included in an amount of, e.g., about 0.001% by weight to about 0.5% by weight, based on the total weight of the slurry composition for the CMP process.

Leveling Agent

In an implementation, the slurry composition for the CMP process may further include a leveling agent for reducing irregularities of a polished surface as desired.

In an implementation, the leveling agent may include, e.g., ammonium chloride, ammonium lauryl sulfate (ALS), polyethylene glycol, polyoxyethylene alkyl ether sulfate (AES) triethylamine, polyvinylpyrrolidone (PVP), or polyacrolein.

The leveling agent may be included in an amount of, e.g., about 0.1% by weight to about 1% by weight, based on the total weight of the slurry composition for the CMP process.

Oxidizer

In an implementation, the slurry composition for the CMP process may further include an oxidizer. In an implementation, the oxidizer may include, e.g., organic peroxides such as peracetic acid, perbenzoic acid, and tert-butyl hydroperoxide; permanganic acid compounds such as potassium permanganate; dichromic acid compounds such as potassium dichromate; halogenacid compounds such as potassium iodate; nitric acid compounds such as nitric acid and iron nitrate; perhalogenic acid compounds such as perchloric acid; persulfates such as sodium persulfate, potassium persulfate, and ammonium persulfate; percarbonates such as sodium percarbonate and potassium percarbonate; urea peroxide; or heteropolyacids.

Corrosion Inhibitor

In an implementation, the slurry composition for the CMP process may further include, e.g., a corrosion inhibitor for protecting a surface to be polished from corrosion, as needed.

In an implementation, the corrosion inhibitor may include, e.g., triazole and derivatives thereof or benzene triazole and derivatives thereof. In an implementation, the triazole derivatives may include, e.g., an amino-substituted triazole compound and a bi-amino-substituted triazole compound.

The corrosion inhibitor may be included in an amount of, e.g., about 0.001% by weight to about 0.15% by weight, based on the total weight of the slurry composition for the CMP process. In an implementation, the corrosion inhibitor may be included in an amount of, e.g., about 0.0025% by weight to about 0.1% by weight or about 0.005% by weight to about 0.05% by weight.

In an implementation, when a CMP process is performed at a pH of about 4.0 and while applying a pressure of about 3 psi to a polysilicon film, the slurry composition for the CMP process may have a polishing rate of, e.g., about 1,600 Å/min to about 3,000 Å/min.

By using the slurry composition for the CMP process, according to the embodiment, product defects and manufacturing costs may be reduced, and product throughput may be increased.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Comparative Example 1

A slurry composition including ceria particles in an amount of 3% by weight, a polymer having a repeating unit of Formula 8′ and a weight-averaged molecular weight of 55,000 as an organic polymer booster in an amount of 2,000 ppm by weight (here, R¹=methyl group), and DIW as a carrier was prepared. A pH of the slurry composition was adjusted to 4.0 by using nitric acid as a pH control agent.

### Comparative Example 2

A slurry composition for a CMP process was prepared in the same manner as in Comparative Example 1 except that ceria particles and an organic polishing booster were omitted.

### Experimental Example 1

A slurry composition for a CMP process was prepared in the same manner as in Comparative Example 1 except that ceria particles were omitted.

Polysilicon layers were polished by using the slurry compositions for the CMP processes, according to Experimental Example 1 and Comparative Examples 1 and 2. A polishing pressure was adjusted to 3 psi, rotation rates of a platen and a carrier head were adjusted to 93 rpm and 87 rpm, respectively, and a flow rate of the slurry composition for the CMP process was adjusted to 250 ml/min. Thicknesses of the polysilicon layers before and after polishing processes were measured, and polishing rates were calculated and are summarized in Table 1.

TABLE 1

| | Polishing rate (Å/min) |
|---|---|
| Experimental Example 1 | 2,000 |
| Comparative Example 1 | 2,200 |
| Comparative Example 2 | 10 |

As shown in Table 1, a polishing rate of the slurry composition including inorganic polishing particles, according to Comparative Example 1, was about 10% higher than a polishing rate of the slurry composition according to Experimental Example 1, which did not include inorganic polishing particles. However, the polishing rate (2,000 Å/min) of the slurry composition according to Experimental Example 1 was also a sufficient polishing rate for an actual process.

Moreover, the slurry composition according to Comparative Example 2, which did not include an organic polishing booster, exhibited an extremely low polishing rate.

### Comparative Examples 3 to 8

In each of Comparative Examples 3 to 8, a slurry composition including ceria particles in an amount of 3% by weight, a compound having a structure indicated in Table 2 as an organic polishing booster in an amount of 2,500 ppm by weight, and DIW as a carrier was prepared. A pH of the slurry composition was adjusted to 4.0 by using nitric acid as a pH control agent.

### Experimental Examples 2 to 7

Slurry compositions for CMP processes were respectively prepared in the same manners as in Comparative Examples 3 to 8 except that ceria particles were omitted.

Polysilicon layers were polished by using the slurry compositions for the CMP processes, according to Experimental Examples 2 to 7 and Comparative Examples 2 to 8. A polishing pressure was adjusted to 3 psi, rotation rates of a platen and a carrier head were adjusted to 93 rpm and 87 rpm, respectively, and a flow rate of the slurry composition for the CMP process was adjusted to 250 ml/min. Thicknesses of the polysilicon layers before and after polishing processes were measured, and polishing rates were calculated and are summarized in Table 2.

TABLE 2

| | Basic | | Polishing rate |
|---|---|---|---|
| | structure | Substituent | (Å/min) |
| Experimental | Formula 1 | R1 = methyl | 1,830 |
| Example 2 | | R2 = H | |
| Comparative | Formula 1 | R1 = methyl | 2,040 |
| Example 3 | | R2 = H | |
| Experimental | Formula 1 | R1 = methyl | 1,910 |
| Example 3 | | R2 = methyl | |
| Comparative | Formula 1 | R1 = methyl | 2,025 |
| Example 4 | | R2 = methyl | |
| Experimental | Formula 2 | R3 = methyl | 2,110 |
| Example 4 | | R4 = methyl | |
| Comparative | Formula 2 | R3 = methyl | 2,450 |
| Example 5 | | R4 = methyl | |
| Experimental | Formula 3 | R5 = methyl | 1,670 |
| Example 5 | | | |
| Comparative | Formula 3 | R5 = methyl | 1,990 |
| Example 6 | | | |
| Experimental | Formula 4 | R6 = methyl | 1,880 |
| Example 6 | | R7 = H | |
| Comparative | Formula 4 | R6 = methyl | 2,080 |
| Example 7 | | R7 = H | |
| Experimental | Formula 4 | R6 = methyl | 2,010 |
| Example 7 | | R7 = methyl | |
| Comparative | Formula 4 | R6 = methyl | 2,170 |
| Example 8 | | R7 = methyl | |

### Experimental Example 8

A slurry composition for a CMP process was prepared in the same manner as in Experimental Example 2 except that a pH of the slurry composition for the CMP process was controlled to be 8.5.

Thereafter, a polysilicon layer was polished by using the slurry composition for the CMP process, according to Experimental Example 8. A polishing pressure was adjusted to 3 psi, rotation rates of a platen and a carrier head were adjusted to 93 rpm and 87 rpm, respectively, and a flow rate of the slurry composition for the CMP process was adjusted to 250 ml/min. Thicknesses of the polysilicon layer before and after a polishing process were measured, and a polishing rate was calculated. As a result, a polishing rate of 1,084 Å/min was obtained.

When the polishing rate of Experimental Example 2 is compared with the polishing rate of Experimental Example 8, it may be seen that a pH of a slurry composition for a CMP process significantly affected a polishing rate thereof.

Hereinafter, a method of manufacturing a semiconductor device by using the above-described CMP process will be described.

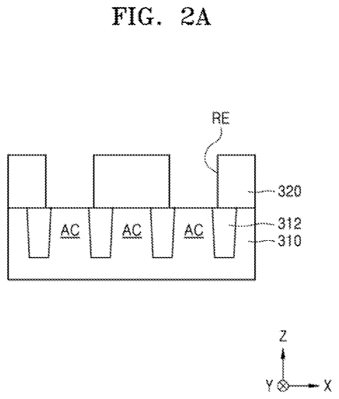

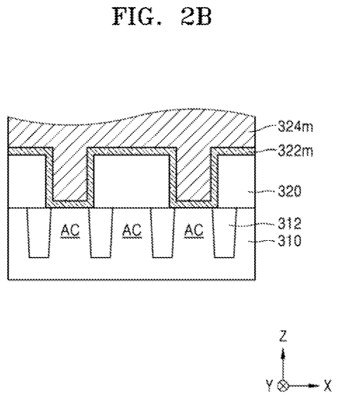

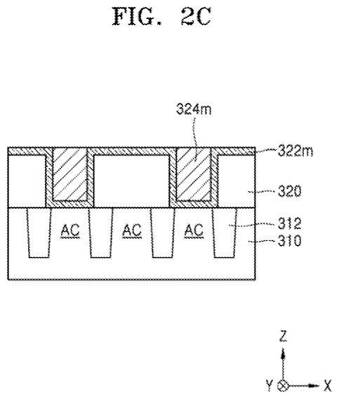

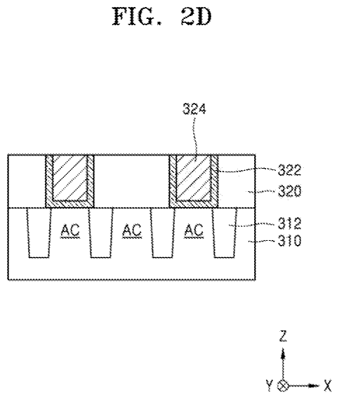

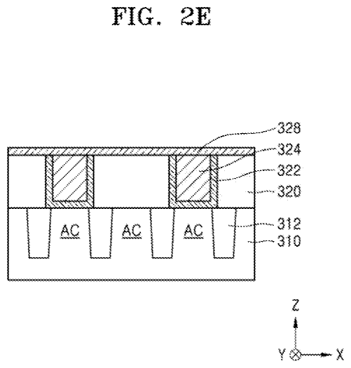

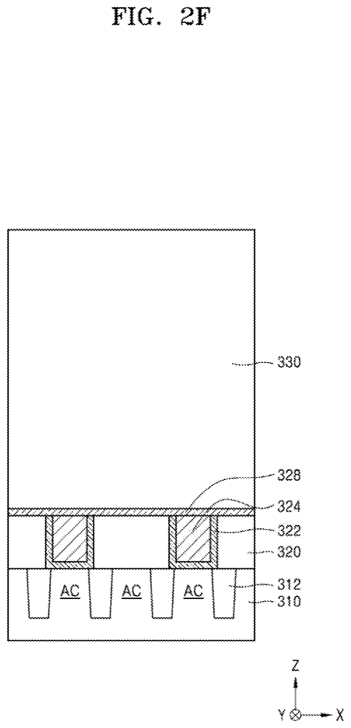

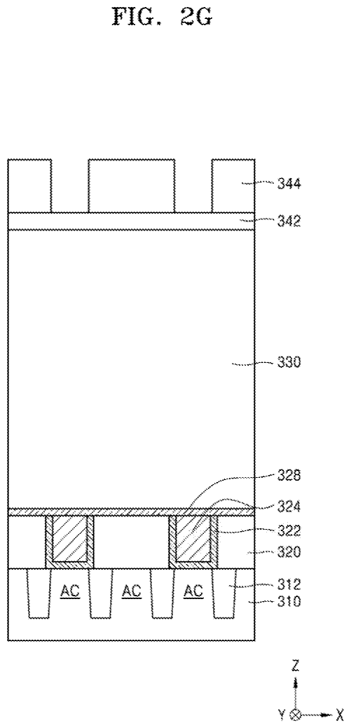

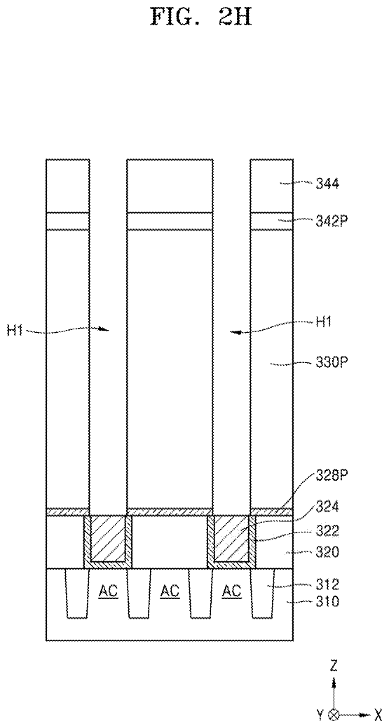

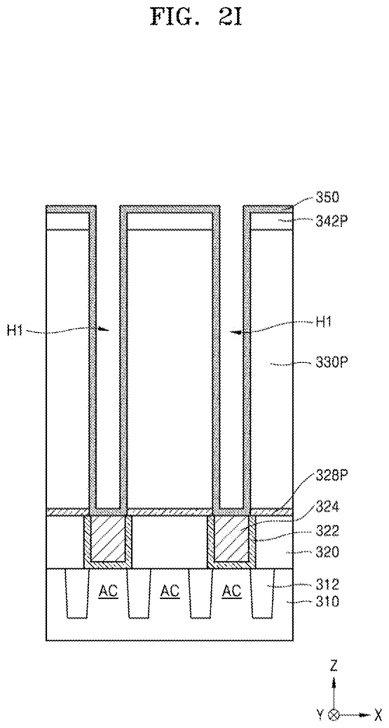

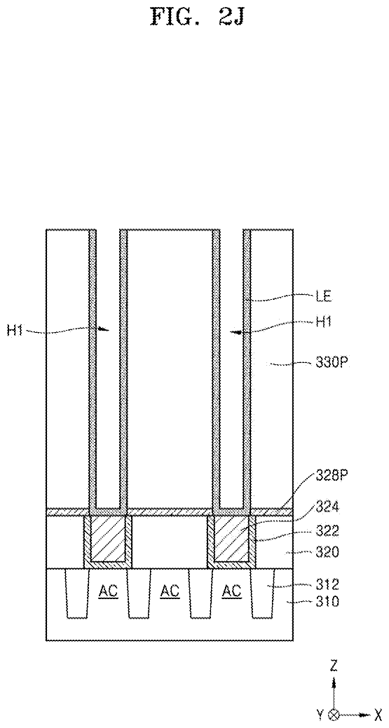

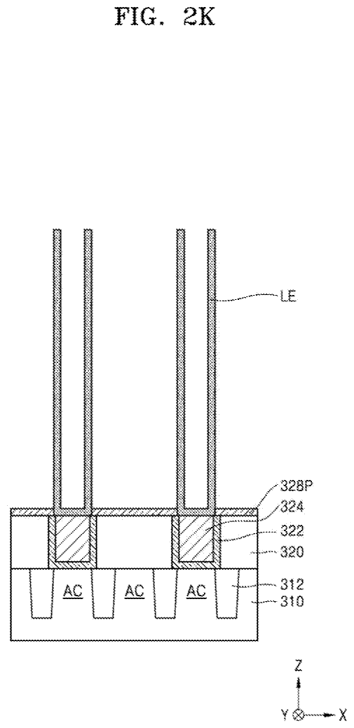

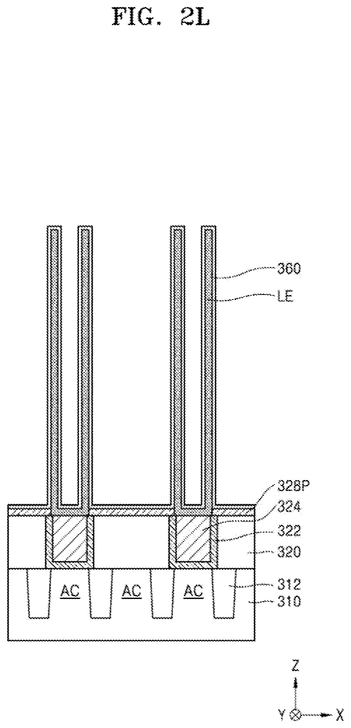

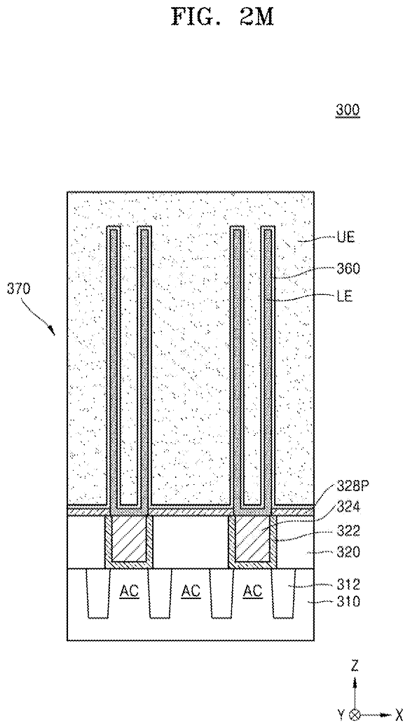

FIGS. 2A to 2M are cross-sectional views of stages in a method of manufacturing a semiconductor device 300 according to an embodiment.

Referring to FIG. 2A, an interlayer insulating film 320 may be formed on a substrate 310 (including a plurality of active regions AC), and may be patterned to expose at least portions of the plurality of active regions AC. The interlayer insulating film 320 may include recess portions RE exposing the active regions AC. The recess portions RE may be contact holes or trenches. In an implementation, the recess portions RE may be contact holes, or the recess portions RE may be trenches.

The substrate 310 may include a semiconductor (e.g., silicon (Si) or germanium (Ge)) or a compound semiconductor (e.g., silicon germanium (SiGe), silicon carbide (SiC), gallium arsenide (GaAs), indium arsenide (InAs), or indium phosphide (InP)). In an implementation, the substrate 310 may include a Group III-V material or a Group IV material. The Group III-V material may be a binary compound, a ternary compound, or a quaternary compound including at least one Group III atom and at least one Group V atom. The Group III-V material may be a compound including a Group III atom (e.g., In, Ga, or Al) and a Group V atom (e.g., arsenic (As), phosphorus (P), or antimony (Sb)). In an implementation, the Group III-V material may include InP, In_{z}Ga_{1-z}As (0≤z≤1), or Al_{z}Ga_{1-z}As (0≤z≤1). The binary compound may be, e.g., InP, GaAs, InAs, InSb, or GaSb. The ternary compound may be, e.g., InGaP, InGaAs, AlinAs, InGaSb, GaAsSb, or GaAsP. The Group IV material may be, e.g., silicon or germanium. In an implementation, the substrate 310 may have a silicon-on-insulator (SOI) structure. The substrate 310 may include a conductive region, e.g., a doped well or a doped structure.

The plurality of active regions AC may be defined by a plurality of device isolation regions 312 formed in the substrate 310. The device isolation regions 312 may include a silicon oxide film, a silicon nitride film, a silicon oxynitride film, or a combination thereof.

The interlayer insulating film 320 may include a silicon oxide film.

Referring to FIG. 2B, a barrier metal material layer 322m may be formed inside the recess portions RE and on an entire top surface of the interlayer insulating film 320. The barrier metal material layer 322m may be formed using an atomic layer deposition (ALD) process, a chemical vapor deposition (CVD) process, or a physical vapor deposition (PVD) process. The barrier metal material layer 322m may include, e.g., titanium (Ti) or titanium nitride (TiN).

In an implementation, a conductive material layer 324m may be formed on an entire top surface of the barrier metal material layer 322m. The conductive material layer 324m may include doped polysilicon or a metal, e.g. tungsten (W), and may be formed using a CVD process.

Referring to FIG. 2C, a CMP process may be performed on the conductive material layer 324m so that the conductive material layer 324m may be defined inside the recess portions RE. In an implementation, the slurry composition for a CMP process according to an embodiment, which has been described above, may be used. In an implementation, inorganic polishing particles, such as silica, ceria, and alumina, may not be included in the slurry composition for the CMP process.

In this case, the CMP process may be performed using the barrier metal material layer 322m as a polishing stop film.

Referring to FIG. 2D, a CMP process may be performed on the barrier metal material layer 322m, which is exposed, so that a barrier metal layer 322 may be defined inside each of the contact holes and the contact holes may be completely node-separated from each other. A plurality of conductive regions 324 may be on the barrier metal layer 322 in the contact holes. To this end, a slurry composition for a CMP process according to an embodiment, which has been described above, may be used.

The CMP process of FIG. 2D may be performed by using the slurry composition that does not include inorganic polishing particles, in the same manner as described with reference to FIG. 2C.

In an implementation, as illustrated in FIGS. 2C and 2D two CMP processes may be respectively performed using the barrier metal material layer 322m and the interlayer insulating film 320 as a polishing stop film. In an implementation, a single CMP process may be performed by using only the interlayer insulating film 320 as a polishing stop film.

In an implementation, the slurry composition for the CMP process may be controlled to have a pH of about 2 to 7. In an implementation, when a metal or polysilicon is polished as shown in FIGS. 2C and 2D, a pH of the slurry composition for the CMP process may be controlled to be an acidic pH value, e.g., 2 to 5.

The plurality of conductive regions 324 may be connected to one of the terminals of switching devices (e.g., field-effect transistors (FETs)) formed on the substrate 310. The plurality of conductive regions 324 may include, e.g., doped polysilicon, metal, conductive metal nitride, metal silicide, or a combination thereof.

Referring to FIG. 2E, an insulating layer 328 may be formed to cover the interlayer insulating film 320 and the plurality of conductive regions 324. The insulating layer 328 may be used as an etch stop layer.

The insulating layer 328 may include an insulating material having an etch selectivity with respect to the interlayer insulating film 320 and a mold film (refer to 330 in FIG. 2F) that will be formed in a subsequent process. In an implementation, the insulating layer 328 may include silicon nitride, silicon oxynitride, or a combination thereof.

In an implementation, the insulating layer 328 may be formed to a thickness of, e.g., about 100 Å to about 600 Å.

Referring to FIG. 2F, the mold film 330 may be formed on the insulating layer 328.

In an implementation, the mold film 330 may include an oxide film. In an implementation, the mold film 330 may include an oxide film, such as a borophosphosilicate glass (BPSG) film, a phosphosilicate glass (PSG) film, an undoped silicate glass (USG) film, a spin on dielectric (SOD) film, or an oxide film formed by using a high-density-plasma chemical vapor deposition (HDP CVD) process. The mold film 330 may be formed using a thermal CVD process or a plasma CVD process. In an implementation, the mold film 330 may be formed to a thickness of, e.g., about 1,000 Å to about 20,000 Å.

In an implementation, the mold film 330 may include a support film. The support film may include a material having an etch selectivity with respect to the mold film 330 and have a thickness of about 50 Å to about 3,000 Å. When the mold film 330 is subsequently removed by using a LAL lift-off process in an etching atmosphere of, e.g., ammonium fluoride (NH₄F), hydrofluoric acid (HF), and water, the support film may include a material having a relatively low etch rate with respect to LAL. In an implementation, the support film may include silicon nitride, silicon carbonitride, tantalum oxide, titanium oxide, or a combination thereof.

Referring to FIG. 2G, a sacrificial film 342 and a mask pattern 344 may be sequentially formed on the mold film 330.

The sacrificial film 342 may include an oxide film, such as a BPSG film, a PSG film, an USG film, an SOD film, or an oxide film formed by using an HDP CVD process. The sacrificial film 342 may have a thickness of about 500 Å to about 2,000 Å. The sacrificial film 342 may help protect the support film included in the mold film 330.

The mask pattern 344 may include an oxide film, a nitride film, a polysilicon film, a photoresist film, or a combination thereof. A region where a lower electrode of a capacitor will be formed may be defined by the mask pattern 344.

Referring to FIG. 2H, the sacrificial film 342 and the mold film 330 may be dry etched by using the mask pattern 344 as an etch mask and using the insulating layer 328 as an etch stop layer, thereby forming a sacrificial pattern 342P and a mold pattern 330P to define a plurality of holes H1.

In this case, the insulating layer 328 may also be etched due to excessive etching, thereby forming an insulating pattern 328P to expose a plurality of conductive regions 324.

Referring to FIG. 2I, the mask pattern 344 may be removed from the resultant structure of FIG. 2H. Thereafter, a conductive film 350 for forming a lower electrode may be formed to cover an inner sidewall of each of the plurality of holes H1, an exposed surface of the insulating pattern 328P, surfaces of the plurality of conductive regions 324 respectively exposed inside the plurality of holes H1, and an exposed surface of the sacrificial pattern 342P.

The conductive film 350 for forming the lower electrode may be conformally formed on the inner sidewall of each of the plurality of holes H1 to leave a partial inner space of each of the plurality of holes H1.

In an implementation, the conductive film 350 for forming the lower electrode may include doped semiconductor, conductive metal nitride, metal, metal silicide, conductive oxide, or a combination thereof. In an implementation, the conductive film 350 for forming the lower electrode may include, e.g., TiN, TiAlN, TaN, TaAlN, W, WN, Ru, RuO₂, SrRuO₃, Ir, IrO₂, Pt, PtO, SrRuO₃ (SRO), (Ba,Sr)RuO₃ (BSRO), CaRuO₃ (CRO), (La,Sr)CoO₃ (LSCo), or a combination thereof.

The conductive film 350 for forming the lower electrode may be formed by using a CVD process, a metal organic CVD (MOCVD) process, or an ALD process. In an implementation, the conductive film 350 for forming the lower electrode may be formed to a thickness of, e.g., about 1 nm to about 100 nm. Thereafter, a sacrificial film may be further formed to fill recess portions defined by the conductive film 350 for forming the lower electrode. The sacrificial film may cover a top surface of the conductive film 350 for forming the lower electrode.

Referring to FIG. 2J, an upper portion of the conductive film 350 for forming the lower electrode may be partially removed so that the conductive film 350 for forming the lower electrode may be separated into a plurality of lower electrodes LE.

To form the plurality of lower electrodes LE, portions of the upper portion of the conductive film 350 for forming the lower electrode and the sacrificial pattern 342P (refer to FIG. 2I) may be removed by using an etchback process or a CMP process so that a top surface of the mold pattern 330P is exposed.

The plurality of lower electrodes LE may pass through the insulating pattern 328P and be connected to the conductive regions 324.

Referring to FIG. 2K, the mold pattern 330P may be removed to expose outer wall surfaces of the plurality of lower electrodes LE having cylindrical shapes.

The mold pattern 330P may be removed by a lift-off process using LAL or hydrofluoric acid.

Referring to FIG. 2L, a dielectric film 360 may be formed on the plurality of lower electrodes LE.

The dielectric film 360 may be formed to conformally cover exposed surfaces of the plurality of lower electrodes LE.

The dielectric film 360 may be formed using an ALD process.

The dielectric film 360 may include an oxide, a metal oxide, a nitride, or a combination thereof. In some embodiments, the dielectric film 360 may include a ZrO₂ film. In an implementation, the dielectric film 360 may include a single ZrO₂ layer or a multilayered structure including a combination of at least one ZrO₂ film and at least one Al₂O₃ film.

In an implementation, the dielectric film 360 may have a thickness of, e.g., about 50 Å to about 150 Å.

Referring to FIG. 2M, an upper electrode UE may be formed on the dielectric film 360.

A capacitor 370 may be configured by the lower electrode LE, the dielectric film 360, and the upper electrode UE.

The upper electrode UE may include a doped semiconductor, a conductive metal nitride, a metal, a metal silicide, a conductive oxide, or a combination thereof. In an implementation, the upper electrode UE may include TiN, TiAlN, TaN, TaAlN, W, WN, Ru, RuO₂, SrRuO₃, Ir, IrO₂, Pt, PtO, SrRuO₃ (SRO), (Ba,Sr)RuO₃ (BSRO), CaRuO₃ (CRO), (La,Sr)CoO₃ (LSCo), or a combination thereof.

The upper electrode UE may be formed by using a CVD process, an MOCVD process, a physical vapor deposition (PVD) process, or an ALD process.

In an implementation, the method of manufacturing the semiconductor device 300 may include the process of forming the dielectric film 360 to cover the surfaces of the lower electrodes LE having cylindrical shapes. In an implementation, pillar-type lower electrodes having no inner spaces may be formed instead of the lower electrodes LE having cylindrical shapes. The dielectric film 360 may be formed on the pillar-type lower electrodes.

In the method of manufacturing the semiconductor device 300 according to the embodiment as described with reference to FIGS. 2A to 2M, a CMP process may be performed by using the slurry composition for the CMP process according to the embodiment to form the barrier metal layer 322 and the conductive regions 324. In an implementation, a CMP process using the slurry composition for the CMP process according to the embodiments may be applied to methods of manufacturing other semiconductor devices.

By way of summation and review, some polishing agents may cause product defects depending on polishing conditions.

One or more embodiments may provide a slurry composition for a CMP process, which may help reduce product defects, incur low manufacturing costs, and increase product throughput.

One or more embodiments may provide a slurry composition for a polysilicon polishing process, which may help reduce product defects, incur low manufacturing costs, and increase product throughput.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A slurry composition for a chemical mechanical polishing (CMP) process, the slurry composition comprising:
an organic polishing booster including an iminium cation;
a carrier; and
optionally including inorganic polishing particles,
wherein, when included, the inorganic polishing particles are included in the slurry composition in an amount of less than 0.1% by weight, based on a total weight of the slurry composition.

2. The slurry composition as claimed in claim 1, wherein the organic polishing booster is included in the slurry composition in an amount of about 10 ppm to about 10,000 ppm by weight.

3. The slurry composition as claimed in claim 1, wherein:
the iminium cation of the organic polishing booster includes an imidazolium cation represented by Formula 1 or Formula 2, 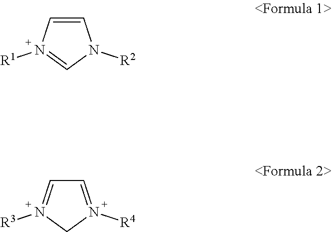
in Formulae 1 and 2, R¹, R², R³, and R⁴ are each independently hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof,
R¹ and R² are separate or are linked to each other to form a ring, and
R³ and R⁴ are separate or are linked to each other to form a ring.

4. The slurry composition as claimed in claim 1, wherein:
the iminium cation of the organic polishing booster includes a pyridinium cation represented by Formula 3, 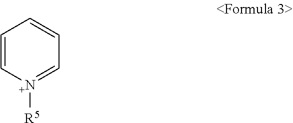
in Formula 3, R⁵ is hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof.

5. The slurry composition as claimed in claim 1, wherein:
the iminium cation of the organic polishing booster includes a triazolium cation represented by Formula 4, Formula 5, or Formula 6, 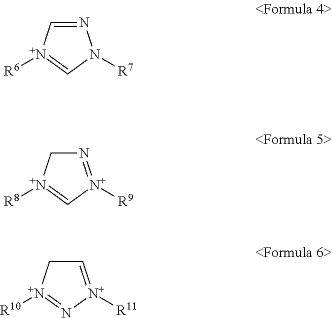
in Formulae 4 to 6, R⁶, R⁷, R⁸, R⁹, R¹⁰, and R¹¹ are each independently hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof,
R⁶ and R⁷ are separate or are linked to each other to form a ring,
R⁸ and R⁹ are separate or are linked to each other to form a ring, and
R¹⁰ and R¹¹ are separate or are linked to each other to form a ring.

6. The slurry composition as claimed in claim 1, wherein:
the iminium cation of the organic polishing booster includes a guanidinium cation represented by Formula 7, 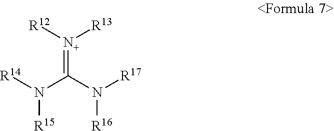
in Formula 7, R¹², R¹³, R¹⁴, R¹⁵, R¹⁶, and R¹⁷ are each independently hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof, and
adjacent ones of R¹², R¹³, R¹⁴, R¹⁵, R¹⁶, and R¹⁷ are separate or are linked to each other to form a ring.

7. The slurry composition as claimed in claim 1, wherein the organic polishing booster includes an oligomer or polymer of a monomer that includes the iminium cation.

8. The slurry composition as claimed in claim 7, wherein the organic polishing booster has a weight-averaged molecular weight Mw of about 3,000 to about 100,000.

9. The slurry composition as claimed in claim 7, wherein:
the organic polishing booster includes a polymer including a repeating unit represented by Formula 8 or Formula 9: 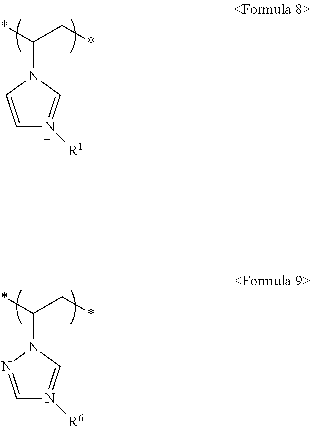
in Formulae 8 and 9, R¹ and R⁶ are each independently hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof.

10. The slurry composition as claimed in claim 1, wherein the slurry composition has a pH of about 2 to about 7.

11. The slurry composition as claimed in claim 1, wherein the slurry composition is essentially free of silica, alumina, ceria, titania, zirconia, magnesia, germania, and mangania.

12. The slurry composition as claimed in claim 11, wherein the slurry composition is essentially free of the inorganic polishing particles.

13. A slurry composition for a chemical mechanical polishing (CMP) process, the slurry composition comprising:
an organic polishing booster;
a surfactant; and
a carrier,
wherein:
the organic polishing booster is included in the slurry composition in an amount of about 10 ppm to about 10,000 ppm by weight, and
the slurry composition is essentially free of inorganic polishing particles.

14. The slurry composition as claimed in claim 13, wherein the slurry composition has a pH of about 2 to about 5.

15. The slurry composition as claimed in claim 13, wherein the organic polishing booster includes an iminium cation.

16. The slurry composition as claimed in claim 15, wherein the slurry composition is essentially free of a dispersion stabilizer.

17. The slurry composition as claimed in claim 15, wherein:
the iminium cation of the organic polishing booster includes a compound represented by one of Formulae 1 to 7, 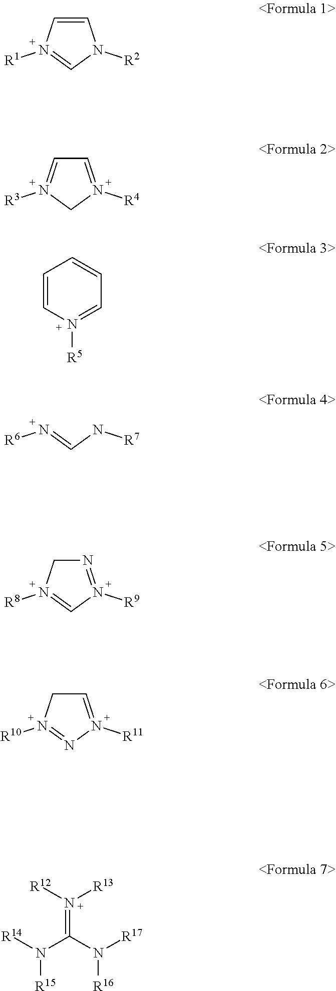
in Formulae 1 to 7, le to R′⁷ are each independently hydrogen, a C1 to C20 straight-chain alkyl group, a C3 to C20 branched alkyl group, a C3 to C20 cycloalkyl group, a C2 to C20 alkenyl group, a C2 to C20 alkynyl group, a C6 to C20 aryl group, a C3 to C20 allyl group, a C1 to C20 alkoxy group, a C6 to C20 aryloxy group, or a combination thereof,
R¹ and R² are separate or are linked to each other to form a ring,
R³ and R⁴ are separate or are linked to each other to form a ring,
R⁶ and R⁷ are separate or are linked to each other to form a ring,
R⁸ and R⁹ are separate or are linked to each other to form a ring,
R¹⁰ and R¹¹ are separate or are linked to each other to form a ring, and
adjacent ones of R¹², R¹³, R¹⁴, R¹⁵, R¹⁶, and R¹⁷ are separate or are linked to each other to form a ring.

18. The slurry composition as claimed in claim 17, wherein the organic polishing booster includes an oligomer or polymer obtained by polymerizing a monomer represented by one of Formulae 1 to 7.

19. The slurry composition as claimed in claim 13, wherein the slurry composition has a polishing rate of about 1,600 Å/min to about 3,000 Å/min in a CMP process performed at a pH of about 4.0 and applying a pressure of about 3 psi to a polysilicon film.

20. A slurry composition for a polysilicon polishing process, the slurry composition comprising:
an organic polishing booster including an iminium cation;
a surfactant;
a pH control agent; and
a carrier,
wherein:
a pH of the slurry composition is in a range of about 2 to about 5, and
the slurry composition is essentially free of inorganic polishing particles and a dispersion stabilizer for uniform distribution of the inorganic polishing particles.
